(19) United States
(12) Patent Application Publication
(10) Pub. No.: US 2014/0116673 A1
(43) Pub. Date: May 1, 2014

(54) AIR CONDITIONER FOR AN ELECTRIC VEHICLE

(71) Applicants: Chisuk Kang, Seoul (KR); Jinmun Kim, Seoul (KR); Jaeyoung Won, Seoul (KR); Donghyuk Lee, Seoul (KR)

(72) Inventors: Chisuk Kang, Seoul (KR); Jinmun Kim, Seoul (KR); Jaeyoung Won, Seoul (KR); Donghyuk Lee, Seoul (KR)

(21) Appl. No.: 13/756,956

(22) Filed: Feb. 1, 2013

(30) Foreign Application Priority Data
Nov. 1, 2012 (KR) 10-2012-0122881

(51) Int. Cl. B60H 1/00

(52) U.S. Cl. CPC B60H 1/00007
USPC 165/222; 237/12.3 R; 165/43; 165/253

(57) ABSTRACT

An air conditioner for an electric vehicle is provided, which may minimize both use of a battery and use of an engine to heat an interior space of the electric vehicle, thereby increasing mileage.

### CROSS-REFERENCE TO RELATED APPLICATION(S)

Pursuant to 35 U.S.C. §119(a), this application claims priority to the Korean Patent Application No. 10-2012-0122881, filed in Korea on Nov. 1, 2012, which is hereby incorporated by reference as if fully set forth herein.

### BACKGROUND

1. Field

An air conditioner for an electric vehicle is disclosed herein.

2. Background

Air conditioners for electric vehicles are known. However, they suffer from various disadvantages.

### BRIEF DESCRIPTION OF THE DRAWINGS

Embodiments will be described in detail with reference to the following drawings in which like reference numerals refer to like elements, and wherein:

FIG. 1 is a schematic diagram of an air conditioner for a hybrid electric vehicle according to an embodiment;

FIG. 2 is a block diagram of the air conditioner of FIG. 1;

FIG. 3 is a schematic diagram of an air conditioner for a hybrid electric vehicle according to another embodiment;

FIG. 4 is a schematic diagram of an air conditioner for a hybrid electric vehicle according to another embodiment;

FIG. 5 is a schematic diagram of an air conditioner for a hybrid electric vehicle according to another embodiment;

FIG. 6 is a graph showing an initial interior space heating rate of the air conditioner of FIG. 5;

FIG. 7 is a schematic diagram of an air conditioner for a hybrid electric vehicle according to another embodiment; and

FIG. 8 is a schematic diagram of an air conditioner for a hybrid electric vehicle according to another embodiment.

### DETAILED DESCRIPTION

An air conditioner for an electric vehicle (hereafter an “air conditioner”) according to embodiments will be described in detail with reference to the attached drawings. Wherever possible, like reference numbers have been used to refer to the same or like elements, and repetitive description has been omitted.

For convenience of description, a size or a shape of a member may be shown exaggerated or not to scale. Though terms including ordinal numbers, such as first or second, can be used for describing various elements, the elements are not confined by the terms, but are used only for making one element distinctive from other elements.

According to recent global environmental regulation strengthening and energy cost reducing trends, demands on environment friendly electric vehicles have increased. The United States and Europe are in a state in which supply of electric vehicles is obliged by legislation of the clean air act, and, in Korea, interest in, and research on, green cars is active as a part of low carbon green growth activity.

An electric vehicle may be provided with a motor that drives the vehicle, a battery mounted thereto that operates various electric devices, and an air conditioner that cools in summer and heats in winter an interior space of the electric vehicle. The air conditioner may have a cycle in which a refrigerant circulates inside of the air conditioner in an order of compression, condensation, expansion, and evaporation to transfer heat. Due to this cycle, the air conditioner is operated in a cooling cycle to discharge the heat outside of the interior space in summer, and in a heating cycle of a heat pump opposite to the cooling cycle, to supply heat to the interior space in winter.

A hybrid electric vehicle is a composite vehicle having a motor and an engine mounted together. The hybrid electric vehicle uses the motor as a power source for starting and low speed operation of the electric vehicle, and uses the engine as a power source in high speed operation of the electric vehicle.

The hybrid electric vehicle may have a structure in which waste heat from the engine produced in running the engine is utilized to heat the interior space. However, although urban driving during which the vehicle runs at a low speed or stops frequently does not require operation of the engine only for running the hybrid electric vehicle, the engine may be operated to heat the interior space.

In order to prevent the engine from operating only to heat the interior space, although a high voltage heater may be used, use of the high voltage heater may require operation of the engine, because the high voltage heater has a large power consumption.

Therefore, an air conditioner for a hybrid electric vehicle is required, which can reduce both use of the engine and use of the battery for interior space heating.

An air conditioner for an electric vehicle according to embodiments may include an engine, a motor, and a battery that drives the motor. As described above, the electric vehicle may be a hybrid electric vehicle that uses the engine or the motor as a driving source.

The air conditioner may include a heat core that recovers waste heat from the engine to heat an interior space of the electric vehicle, an air conditioner device having a compressor driven by the motor, an indoor heat exchanger, an outdoor heat exchanger, and a controller that controls operation of the engine, the heat core, and the air conditioner device. In running of the electric vehicle, the controller may operate the air conditioner device first to heat the interior space, in a battery running mode, and may operate the heat core first to heat the interior space, in an engine running mode. When the electric vehicle stops, the controller may stop operation of the engine, and operate the air conditioner device first to heat the interior space.

The term indoor or interior space refers to the passenger cab of the electric vehicle. The term indoor heat exchanger refers to a heat exchanger that heat exchanges with indoor air or air within indoor or interior space of the electric vehicle. The term outdoor heat exchanger refers to a heat exchanger that heat exchanges with outdoor air or air outside of the interior space in the electric vehicle.

An air conditioner according to various embodiments will be described in detail with reference to the attached drawings.

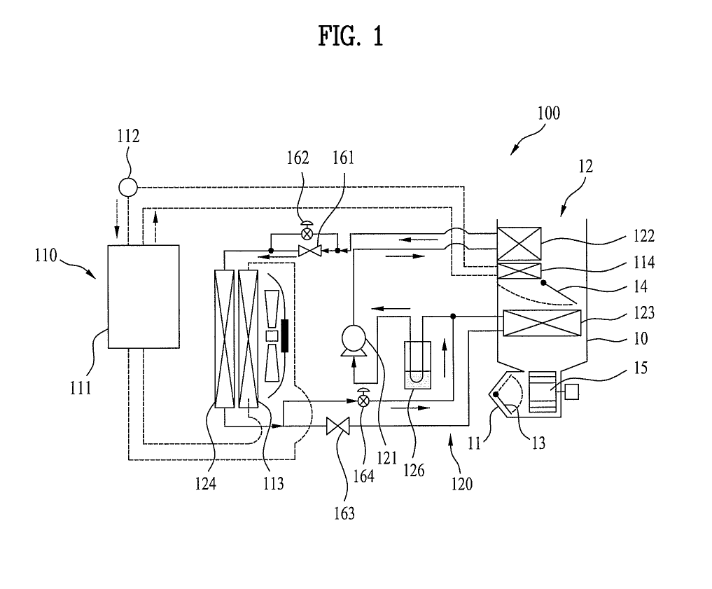

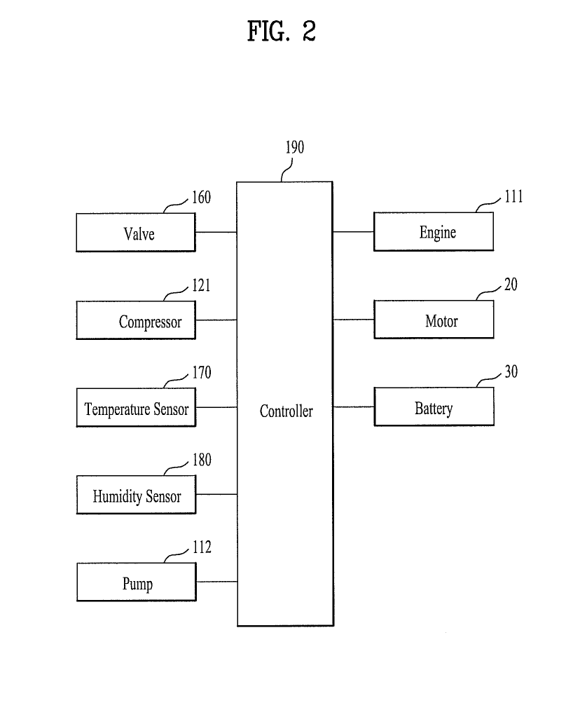

FIG. 1 is a schematic diagram of an air conditioner for a hybrid electric vehicle according to an embodiment, and FIG. 2 is a block diagram of the air conditioner of FIG. 1. The air conditioner 100 of FIG. 1 may include a heat core 114. The heat core 114 may recover waste heat from an engine 111 to heat an interior space of the vehicle. A waste recovery device 110 may include the engine 111, a radiator 113, and the heat core 114, through which cooling water having waste heat recovered from the engine 111 may flow. The waste heat recovery device 110 may further include a pump 112 that pumps the cooling water.

In one operation, the cooling water having waste heat recovered from the engine 111 may flow through the heat core 114, to allow heat exchange between the cooling water and interior space air. In this case, the cooling water heated higher than a predetermined temperature due to operation of the engine 111 may heat the interior space air.

The heat core 114, a plurality of dampers 13 and 14 that control flow directions of the air, and a fan 15 may be arranged in a duct 10 through which air may be introduced into the indoor or interior space of the electric vehicle. An air inlet 11 and an air outlet 12 may be provided in the duct 10.

An air conditioner device 120 may be provided and may include a compressor 121 that compresses refrigerant, at least one indoor heat exchanger 122, 123 and an outdoor heat exchanger 124 that cool or heat the interior space, and a plurality of valves 161 to 164, which may be referred to collectively as “valve 160”. The air conditioner device 120 may also include a flow change-over valve (for example, a four-way valve) that changes a flow direction of the refrigerant to enable the indoor heat exchanger(s) to be operated as an evaporator or a condenser depending on the flow direction of the refrigerant.

If a plurality of indoor heat exchangers are provided, the indoor heat exchangers may include an indoor heating heat exchanger 122 and an indoor cooling heat exchanger 123, arranged in the duct 10. An accumulator 126 may be provided on a refrigerant inlet side of the compressor 121.

The air conditioner 100 may further include one or more temperature sensors 170 and one or more humidity sensors 180 that measure a temperature of the interior space, an outdoor temperature, and a humidity of the interior space.

In this embodiment, the indoor heat exchangers 122 and 123 include the indoor heating heat exchanger 122 and the indoor cooling heat exchanger 123. However, embodiments are not so limited.

Referring to FIGS. 1 and 2, a first electronic expansion valve 161 and a first solenoid valve 162 may be provided in parallel to each other between the indoor heating heat exchanger 122 and the outdoor heat exchanger 124. A second electronic expansion valve 163 and a second solenoid valve 164 may be provided in parallel to each other between the indoor cooling heat exchanger 123 and the outdoor heat exchanger 124.

As set forth above, the electronic expansion valves 161 and 163 and the solenoid valves 162 and 164 may be referred to collectively as valve 160. Further, a controller 190 may be provided to control opening of the valve 160, and the valve 160 may include at least one electronic expansion valve 161 or 163 and at least one solenoid valve 162 or 164.

In a case in which the air conditioner device 120 serves as a heat pump, the controller 190 may close the first solenoid valve 162, and open the first electronic expansion valve 161, so that the refrigerant having passed through the indoor heating heat exchanger 122 passes through the first electronic expansion valve 161. The controller 190 may also close the second solenoid valve 163 and opens the second solenoid valve 164, so that the refrigerant having passed through the outdoor heat exchanger 124 passes through the second solenoid valve 164.

The refrigerant compressed at the compressor 121 may be introduced to the indoor heating heat exchanger 122. In this case, the refrigerant heat may exchange with the interior space air as the refrigerant passes through the indoor heating heat exchanger 122 to condense the refrigerant, and the refrigerant condensed thus may be expanded by the first electronic expansion valve 161.

The refrigerant having passed through the first electronic expansion valve 161 may be introduced to the outdoor heat exchanger 124, heat exchange with outdoor air as the refrigerant passes through the outdoor heat exchanger 124 to evaporate the refrigerant in the outdoor heat exchanger 124. The refrigerant discharged from the outdoor heat exchanger 124 may pass through the second solenoid valve 164, be introduced to the accumulator 126, and the compressor 121, in succession.

The air conditioner device 120 may heat as well as dehumidify the interior space. The controller 190 may control the refrigerant having passed through the indoor heating heat exchanger 122 to pass the first solenoid valve 162 by opening the first solenoid valve 162 and closing the first electronic expansion valve 161, and control the refrigerant having passed through the outdoor heat exchanger 124 to pass through the second electronic expansion valve 163 by closing the second solenoid valve 164 and opening the second electronic expansion valve 163. In this case, the refrigerant may be condensed at the indoor heating heat exchanger 122, and evaporated at the indoor cooling heat exchanger 123. The indoor cooling heat exchanger 123 may be arranged closer to the air inlet 11 of the duct 10 than the indoor heating heat exchanger 122. Therefore, the air introduced to the air inlet 11 of the duct 10 may be dehumidified as the air passes through the indoor cooling heat exchanger 123 and heated as the air passes through the indoor heating heat exchanger 122, in succession, and supplied to the interior space through the air outlet 12 in the duct 10.

The air conditioner device 120 of the air conditioner 100 of this embodiment may perform heating of the interior space or heating and dehumidifying of the interior space by the controller 190, selectively. That is, the controller 190 may operate the indoor heating heat exchanger 122 to heat the interior space, or if the interior space has a humidity higher than a predetermined value, may operate both the indoor cooling heat exchanger 123 and the indoor heating heat exchanger 122 at the same time.

The compressor 121 of the air conditioner device 120 may be driven by a motor 20, and the motor 20 may receive power supplied by a battery 30. If the battery 30 has a charge level lower than a predetermined value, the engine 111 may be driven to charge the battery 30. Accordingly, it is required that the heat core 114 and the air conditioner device 120 be controlled appropriately to meet an interior space heating load, as well as improve mileage.

In running of the electric vehicle, the air conditioner 100 according to this embodiment may operate the air conditioner device 120 first to heat the interior space, in a battery running mode, and may operate the heat core 114 first to heat the interior space, in an engine running mode. When the electric vehicle is not running, the controller 190 may stop operation of the engine 111, and operate the air conditioner device 120 first to heat the interior space. That is, in order to prevent the engine 111 from operating only to heat the interior space, and to improve mileage in a case in which the electric vehicle is not running, the controller 190 may operate the air conditioner device 120 first to heat the interior space.

The battery running mode may refer to a state in which the electric vehicle runs on the motor 20 as a driving source and the engine 111 is not in operation, for example, in an initial running or a slow speed running. The engine running mode may refer to a state in which the electric vehicle runs on the engine 111 as a driving source, for example, in a high speed running.

A battery driving mode may refer to a state in which the electric vehicle is driven using the motor 20. An engine running mode may refer to a state in which the electric vehicle is driven using the engine 111.

In the battery driving mode, if an interior space heating capacity of the air conditioner device 120 is lower than a required interior space heating load, the controller 190 may control the air conditioner device 120 and the heat core 114 to run at the same time, to heat the interior space. More specifically, in the battery driving mode, the controller 190 may operate the air conditioner device 120 first to heat the interior space, and in this state, if the interior space heating capacity of the air conditioner device 120 is lower than the required interior space heating load, the controller 190 may also operate the heat core 114 to heat the interior space.

In the engine driving mode, if an interior space heating capacity of the heat core 114 is lower than the required interior space heating load, the controller 190 may control the heat core 114 and the air conditioner device 120 to run at the same time, to heat the interior space. More specifically, in the engine driving mode, the controller 190 may operate the heat core 114 first to heat the interior space, and in this state, if the interior space heating capacity of the heat core 114 is lower than the required interior space heating load, the controller 190 may also operate the air conditioner device 120 to heat the interior space. However, if the electric vehicle changes from a running state to a stationary state, and the interior space heating capacity of the heat core 114 is higher than the required interior space heating load, the controller 190 may control the heat core 114 to heat the interior space in a state in which the electric vehicle (engine) is in the stationary state.

As described above, while the electric vehicle is running, a temperature of cooling water may rise as the engine is running. If the electric vehicle changes to a stationary state, and if the heating capacity of the heat core 114, which heats the interior space due to the flow of the cooling water, is higher than the required interior space heating load, the controller 190 may control the heat core 114 to keep heating the interior space in a state in which the electric vehicle (engine) is in the stationary state. Controlling the heat core 114 to keep heating the interior space in a state in which the electric vehicle (engine) is in the stationary state implies that only the pump 112 in the waste heat recovery device 110 is running.

The heating capacity of the heat core 114 may vary with a temperature of the cooling water. In one mode of this embodiment, as the heat core 114 may have an adequate interior space heating capacity if the temperature of the cooling water being introduced to the heat core 114 is higher than about 60° C., in such a case even if the electric vehicle changes to the stationary state, the pump 112 may be operated to heat the interior space with the heat core 114 in order to reduce mileage. Alternatively, if the electric vehicle changes from the running state to the stationary state, and the interior space heating capacity of the heat core 114 is lower than the required interior space heating load, the controller 190 may operate the air conditioner device 120 first to heat the interior space in a state in which the electric vehicle (engine) is in the stationary state.

As described above, the heating capacity of the heat core 114 may vary with the temperature of the cooling water. As, in general, the heat core 114 may have a sufficient interior space heating capacity if the temperature of the cooling water being introduced to the heat core 114 is higher than about 60° C., the heat core 114 may heat the interior space, singly or by itself.

That is, in the engine running mode, the engine is in operation and generates a lot of heat, thereby maintaining the interior space heating capacity of the heat core 114 at a level at which the required interior space heating load is met. However, in a state in which the engine is not in operation, to run the electric vehicle using the motor, the temperature of the cooling water necessarily drops.

The heat core 114 may be positioned closer to the air inlet 12 than at least one of the indoor heat exchanger(s). Further, if the indoor heat exchanger(s) include the indoor cooling heat exchanger 123 and the indoor heating heat exchanger 122, the indoor cooling heat exchanger 123 and the indoor heating heat exchanger 122 may be arranged in succession along the duct 10 starting from the air inlet 11 to the air outlet 12.

In more detail, an arrangement of the heat core 114 and the indoor heating heat exchanger 122 in view of interior space heating may be as follows. The temperature of the cooling water necessarily drops in a state in which the electric vehicle runs using the motor 20 without running the engine 111. In this case, the interior space air may heat exchange at the heat core 114, which has a relatively low temperature first, heat exchange at the indoor heating heat exchanger 122, which has a relatively high temperature, second, and be discharged to the interior space. If the temperature of the cooling water circulating through the heat core 114 is lower than a predetermined temperature, the controller 190 may operate the heat core 114 and the indoor heating heat exchanger 122 at the same time, to heat the interior space. Alternatively, if the temperature of the cooling water circulating through the heat core 114 is higher than a predetermined temperature (about 60° C.), the controller 190 may operate the heat core 114 singly or by itself, to heat the interior space.

With this embodiment, single or simultaneous operation of the air conditioner device 120 and the heat core 114 has been described to reduce mileage. All of such control methods may be applicable to each of the further embodiments described hereinbelow. Air conditioners according to embodiments described hereinbelow may have a difference from the air conditioner 100 of the embodiment in a configuration of the air conditioner device and/or in a position of the heat core. The embodiments will be described focused on the differences, and repetitive disclosure has been omitted.

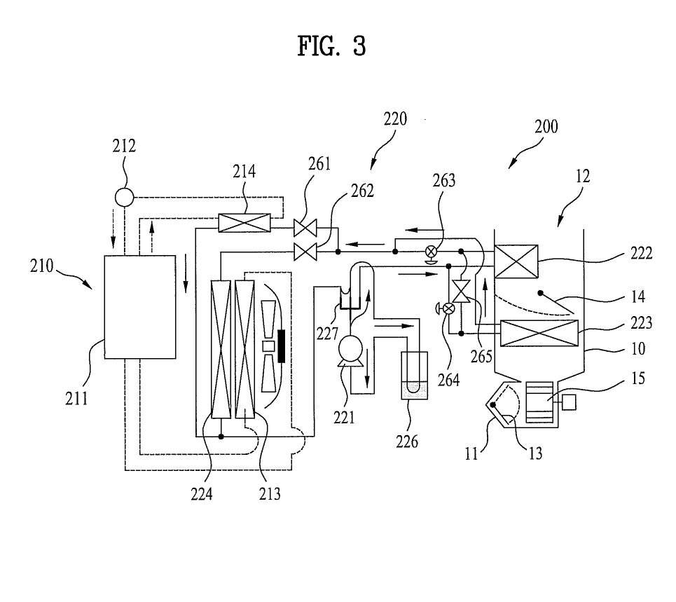

FIG. 3 is a schematic diagram of an air conditioner for a hybrid electric vehicle according to another embodiment. Referring to FIG. 3, the air conditioner 200 may include a waste heat recovery device 210 that recovers waste heat from the engine 211, and an air conditioner device 220.

The waste heat recovery device 210 may include the engine 211, a radiator 213, and a heat core 214, through which cooling water having the waste heat recovered from the engine 211 may flow. The waste heat recovery device 210 may further include a pump 212 that pumps the cooling water.

In this embodiment, the heat core 214 may not heat the interior space directly using heat of the cooling water, but rather, may heat exchange with the refrigerant from the indoor heat exchanger 222, to heat the refrigerant introduced to the outdoor heat exchanger 224. That is, the heat core 214 may elevate an evaporation temperature of the refrigerant with waste heat from the engine 211.

In more detail, the cooling water having the waste heat recovered from the engine 211 may flow through the heat core 214, to heat exchange with the refrigerant from the indoor heat exchanger 222 as it flows through the heat core 214. The cooling water heated higher than a predetermined temperature due to running of the engine 211 may heat the refrigerant from the indoor heat exchanger 222 to elevate an evaporation temperature of the refrigerant.

The air conditioner device 220 may include a compressor 221 that compresses the refrigerant, a plurality of indoor heat exchangers 222 and 223 and an outdoor heat exchanger 224, and a plurality of valves 261 to 265, that cool or heat an interior space of the electric vehicle. The air conditioner device 220 may include a flow change-over valve 227 that changes a direction of the refrigerant flow, and an accumulator 226 provided at a refrigerant inlet of the compressor 221.

The plurality of indoor heat exchangers 222 and 223 may be a first indoor heat exchanger 222 and a second indoor heat exchanger 223. The first indoor heat exchanger 222 may be arranged closer to the air outlet 12 than the second indoor heat exchanger 223.

As described with respect to the embodiment of FIG. 1, the controller 190 may control opening of each of the valves 261 to 265 to control the first indoor heat exchanger 222 and the second indoor heat exchanger 223 to be operated as a condenser or an evaporator, respectively. That is, if it is intended to heat the interior space with the air conditioner device 220, the interior space may be heated by operating the first indoor heat exchanger 222 singly to introduce the refrigerant only to the first indoor heat exchanger 222, or the interior space may be heated by operating the first indoor heat exchanger 222 and the second indoor heat exchanger 223 to introduce the refrigerant to both the first and second indoor heat exchangers 222 and 223. If the interior space has a humidity higher than a predetermined humidity, the controller 190 may operate the first indoor heat exchanger 222 as a condenser to heat the interior space, and operate the second indoor heat exchanger 223 as an evaporator to dehumidify the air being introduced into the duct 10.

In this embodiment, the controller 190 may control the cooling water to heat exchange with the refrigerant from the first indoor heat exchanger 222 only if the temperature of the cooling water is higher than an outdoor temperature. More specifically, if the temperature of the cooling water is higher than the outdoor temperature, the controller 190 may open the first electronic expansion valve 261, and may close the second electronic expansion valve 162, to direct the refrigerant to heat exchange with the cooling water flowing through the heat core 214. Alternatively, if the temperature of the cooling water is lower than the outdoor temperature, the controller 190 may close the first electronic expansion valve 261, and open the second electronic expansion valve 262, so that the refrigerant does not heat exchange with the cooling water, but rather, is introduced to the outdoor heat exchanger 224, directly.

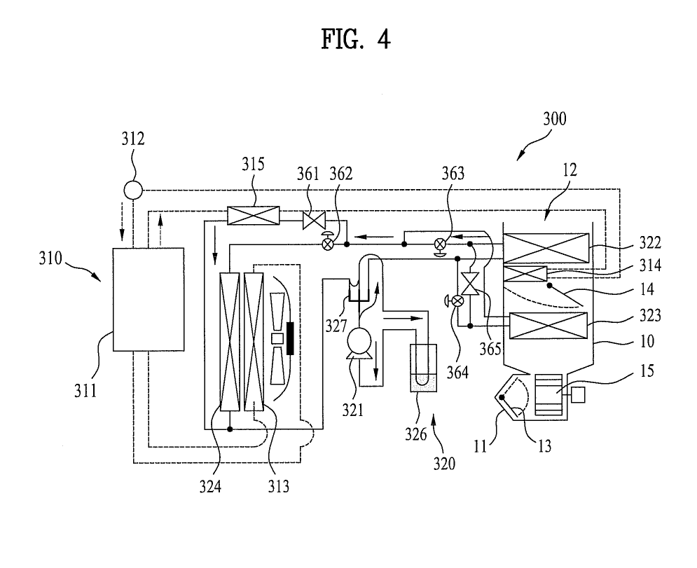

FIG. 4 is a schematic diagram of an air conditioner for a hybrid electric vehicle according to another embodiment. Referring to FIG. 4, the air conditioner 300 may include a waste heat recovery device 310 that recovers waste heat from an engine 311, and an air conditioner device 320.

The waste heat recovery device 310 may include the engine 311, a radiator 313, a first heat core 314, and a second heat core 315, through which cooling water having waste heat recovered from the engine 311 may flow. The waste heat recovery device 310 may further include a pump 312 that pumps the cooling water.

In this embodiment, the first heat core 314 may be arranged in the duct 10, into which the air of the interior space of the electric vehicle may be introduced to heat the air of the interior space with heat of the cooling water. As described above, a plurality of dampers 13 and 14, and a fan 14 may be provided in the duct 10, that control flow directions of the air.

The first heat core 314 may heat the interior space of the electric vehicle with the waste heat recovered from the engine 311. In one mode, the cooling water having the waste heat recovered from the engine 311 may flow to the first heat core 314, to heat exchange with the air as it flow through the first heat core 314. The cooling water heated higher than a predetermined temperature due to running of the engine 311 may heat the air to heat the interior space.

The second heat core 315 may not directly heat the interior space using heat of the cooling water, but rather, may heat the refrigerant being introduced to an outdoor heat exchanger 324 by heat exchanging with the refrigerant from an indoor heat exchanger 322. That is, the second heat core 315 may elevate an evaporation temperature of the refrigerant with the waste heat recovered from the engine 311. In more detail, the cooling water having the waste heat recovered from the engine 311 may flow through the second heat core 315, to heat exchange with the refrigerant from the indoor heat exchanger 322 as the cooling water flows through the second heat core 315, to elevate an evaporation temperature of the refrigerant.

In summary, the waste heat recovery device 310 of this embodiment may perform all functions of the waste heat recovery device 110 of FIG. 1 and the waste heat recovery device 210 of FIG. 3. Further, in the waste heat recovery device 310 of FIG. 4, the cooling water having the waste heat recovered from the engine 311 may be directed to flow through the second heat core 315 and the first heat core 314, in succession (see FIG. 4). Alternatively, the cooling water having the waste heat recovered from the engine 311 may be directed to flow (not shown) through the first heat core 314 and the second heat core 315, in succession.

The air conditioner device 320 may include a compressor 321 that compresses the refrigerant, a plurality of indoor heat exchangers 322 and 323, an outdoor heat exchanger 324, and a plurality of valves 361 to 365, that heat or cool the interior space. The air conditioner device 320 may further include a flow change-over valve 327 that changes a direction of the refrigerant flow, and an accumulator 326 provided at a refrigerant inlet of the compressor 321.

The plurality of indoor heat exchangers 322 and 323 may include a first indoor heat exchanger 322 and a second indoor heat exchanger 323. The first indoor heat exchanger 322 may be arranged closer to the air outlet 12 than the second indoor heat exchanger 323.

As described above with respect to the embodiments of FIGS. 1 and 3, the controller 190 may control opening of each of the valves 361 to 365, such that the first indoor heat exchanger 322 and the second indoor heat exchanger 323 operate as a condenser or an evaporator. In more detail, if it is intended to heat the interior space with the air conditioner device 310, the interior space may be heated by operating the first indoor heat exchanger singly or by itself to introduce the refrigerant only to the first indoor heat exchanger 322, or the interior space may be heated by operating both the first indoor heat exchanger 322 and the second indoor heat exchanger 323 to introduce the refrigerant to the first and second indoor heat exchangers 322, 323.

The first indoor heat exchanger 322 may be an indoor heating heat exchanger, and the second indoor heat exchanger 323 may be an indoor cooling heat exchanger. If the interior space has a humidity higher than a predetermined humidity, the controller 190 may operate the first indoor heat exchanger 322 as a condenser to heat the interior space, and operate the second indoor heat exchanger 323 as an evaporator to dehumidify the air being introduced to the duct 10. The second indoor heat exchanger 323, the first heat core 314, and the first indoor heat exchanger 322 may be arranged in succession, starting from the air inlet 11 to the air outlet 12 as described with respect to the embodiment of FIG. 1.

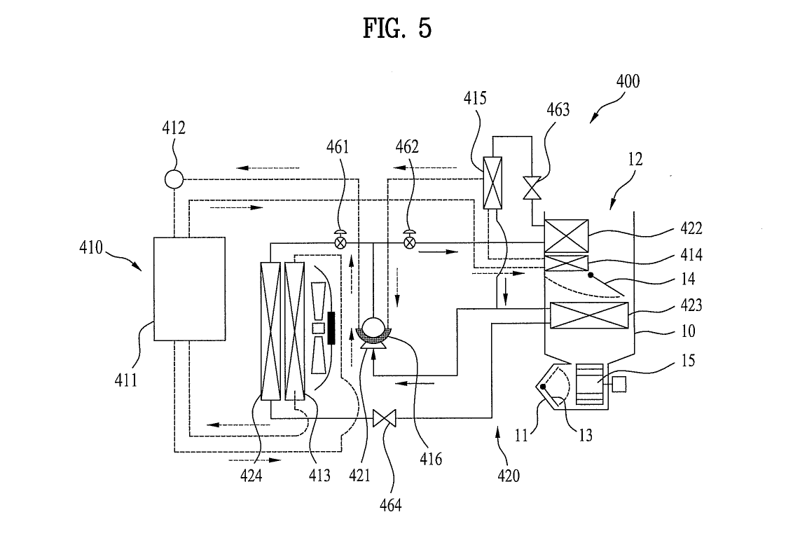

FIG. 5 is a schematic diagram of an air conditioner for a hybrid electric vehicle according to another embodiment. Referring to FIG. 5, the air conditioner 400 may include a waste heat recovery device 410 that recovers waste heat from an engine 411, and an air conditioner device 420.

The waste heat recovery device 440 may include the engine 411, a radiator 413, a first heat core 414, and a second heat core 415, through which cooling water having the waste heat recovered from the engine 411 may flow. The waste heat recovery device 410 may further include a pump 412 that pumps the cooling water.

The first heat core 414 of this embodiment may be arranged in the duct 10, into which air of the interior space of the electric vehicle may be introduced to perform heating of the interior space with heat of the cooling water. As described above, a plurality of dampers 13 and 14 that control flow directions of the air and a fan 14 may be provided in the duct 10.

The first heat core 414 may heat the interior space of the electric vehicle with the waste heat recovered from the engine 411. In more detail, the cooling water having the waste heat recovered from the engine 411 may flow through the first heat core 414, to heat exchange with the air as it flows through the first heat core 414. The cooling water heated higher than a predetermined temperature due to running of the engine 411 may heat the air to heat the interior space.

The second heat core 415 may not heat the interior space directly using heat of the cooling water, but rather, may heat the refrigerant being introduced to the compressor 421 by heat exchanging with the refrigerant from an indoor heat exchanger 422. In more detail, the cooling water having the waste heat recovered from the engine 411 may flow through the second heat core 415, to heat exchange with the refrigerant from the indoor heat exchanger 422 as the cooling water flows through the second heat core 415.

In the waste heat recovery device 410 of this embodiment, the cooling water having the waste heat recovered from the engine may be directed to flow through the first heat core 414 and the second heat core 415, in succession (see FIG. 5). Alternatively, the cooling water having the waste heat recovered from the engine 411 may be directed to flow (not shown) through the second heat core 415 and the first heat core 414, in succession.

The air conditioner device 420 may further include the compressor 421 that compresses the refrigerant, a plurality of indoor heat exchangers 422 and 423 and an outdoor heat exchanger 424, and a plurality of valves 461 to 464, that cool or heat the interior space of the electric vehicle. The plurality of indoor heat exchangers 422 and 423 may be a first indoor heat exchanger 422 and a second indoor heat exchanger 423. The first indoor heat exchanger 422 may be arranged closer to the air outlet 12 than the second indoor heat exchanger 423.

As described above with respect to the embodiments of FIGS. 1 and 3, the controller 190 may control opening of each of the valves 461 to 464 to operate the first indoor heat exchanger 422 and the second indoor heat exchanger 423 as a condenser or an evaporator, respectively. That is, if it is intended to heat the interior space with the air conditioner device 420, the interior space may be heated by operating the first indoor heat exchanger 422 singly to introduce the refrigerant only to the first indoor heat exchanger 422. Further, if the interior space has a humidity higher than predetermined humidity, the controller 190 may operate the first indoor heat exchanger 422 as a condenser to heating the interior space, and may operate the second indoor heat exchanger 423 as an evaporator to dehumidify the room air being introduced to the duct 10.

The second indoor heat exchanger 423, the first heat core 414, and the first indoor heat exchanger 422 may be arranged in succession, starting from the room air inlet 11 to the room air outlet 12, as described with respect to the embodiment of FIG. 1.

With this embodiment, the waste heat recovery device 410 may include a water jacket 416, through which the cooling water may pass to recover the waste heat from the engine 411. The water jacket 416 may be provided at the compressor 421. The cooling water may heat oil in the compressor 411 as it passes through the water jacket 416, and as a viscosity of the oil increases in the air conditioner device 410, a interior space heating effect may be quickly obtained.

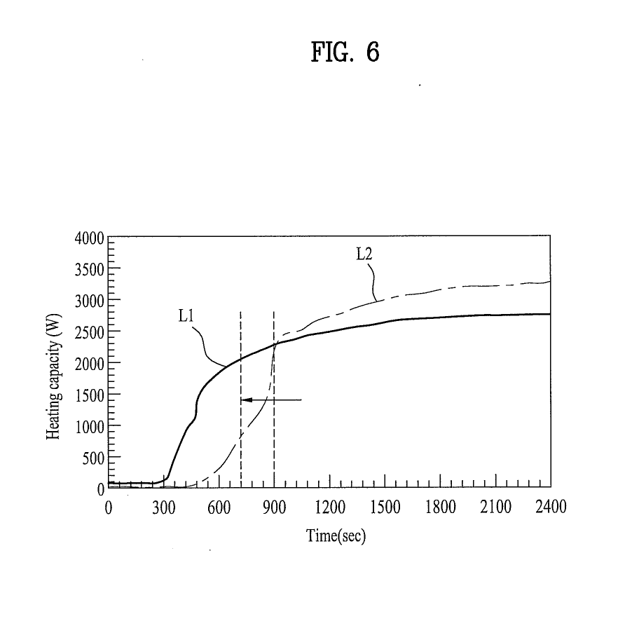

FIG. 6 illustrates a graph showing performance of the air conditioner of FIG. 5. The graph of FIG. 6 shows an initial room heating rate due to the water jacket, with a longitudinal axis denoting heating capacity and a transverse axis denoting time. Referring to FIG. 6, it can be noted that a case L1 in which the water jacket is used has an initial heating rate improved by about 30% greater than a case L2 in which the water jacket is not used.

If an outdoor temperature is higher than a predetermined value, the controller 190 may control the cooling water to be introduced directly to one of the heat cores (the first heat core 414 or the second heat core 415), and if the outdoor temperature is lower than a predetermined value, the controller 190 may control the cooling water to be introduced to one of the heat cores (the first heat core 414 or the second heat core 415) after the cooling water has passed through the water jacket 416. If the outdoor temperature is higher than the predetermined value, an effect due to the water jacket 416 may not actually be higher. That is, the effect due to the water jacket 416 increases as the outdoor temperature decreases.

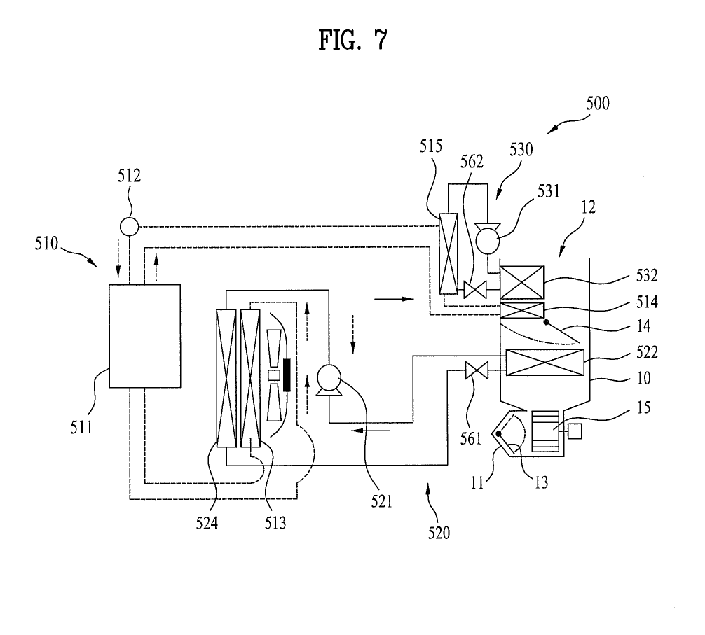

FIG. 7 illustrates a schematic diagram of an air conditioner for a hybrid electric vehicle according to another embodiment. Referring to FIG. 7, the air conditioner 500 may include a waste heat recovery device 510 that recovers the waste heat from an engine 511, a main air conditioner device 520, and a sub-air conditioner device 530.

The waste heat recovery device may include the engine 511, a radiator 513, a first heat core 514, and a second heat core 515, through which cooling water having waste heat recovered from the engine 511 may flow. The waste heat recovery device 510 may further include a pump 512 that pumps the cooling water.

The first heat core 514 of this embodiment may be arranged in the duct 10, into which air of the interior space of the electric vehicle may be introduced to heat the interior space with heat of the cooling water. As described above, a plurality of dampers 13 and 14 that control flow directions of the air and a fan 15 may be provided in the duct 10.

The first heat core 514 may heat the interior space of the electric vehicle with the waste heat recovered from the engine 511. In more detail, the cooling water having the waste heat recovered from the engine 511 may flow through the first heat core 514, to heat exchange with the air as it flows through the first heat core 514. The cooling water heated higher than a predetermined temperature due to running of the engine 511 may heat the air to heat the interior space.

The main air conditioner device 520 may include a compressor 521 that compresses a refrigerant, an indoor heat exchanger 522 and an outdoor heat exchanger 524, that cool or heat the interior space of the electric vehicle, and at least one valve 561. The main air conditioner device 520 may be configured to be operated only in either one of an interior space heating cycle or an interior space cooling cycle.

The sub-air conditioner device 530 may include a compressor 531 that compresses a refrigerant, an indoor heat exchanger 532 and an outdoor heat exchanger (the second heat core) 515, that cool or heat the interior space of the electric vehicle, and at least one valve 562. The sub-air conditioner device 530 may be configured to be operated only in either one of an interior space heating cycle or an interior space cooling cycle.

The compressor 521 of the main air conditioner device 520 may have a capacity larger than a capacity of the compressor 531 of the sub-air conditioner device 530. For example, the capacity of the compressor 531 of the sub-air conditioner device 530 may be ⅓ of the capacity of the compressor 521 of the main air conditioner device 520.

The indoor heat exchanger 522 and the first heat core 514 of the main air conditioner device 520 and the indoor heat exchanger 532 of the sub-air conditioner device 530 may be arranged in succession starting from the air inlet 11 to the air outlet 12.

The second heat core 515 may perform a function of an outdoor heat exchanger of the sub-air conditioner device 530. That is, the outdoor heat exchanger (the second heat core) 515 of the sub-air conditioner device 530 may provide heat exchange, not between the refrigerant and the outdoor air, but between the refrigerant and the cooling water.

The controller 190 may operate at least one of the main air conditioner device 520, the sub-air conditioner device 530, or the first heat core 514 singly or simultaneously with reference to an outdoor temperature, a temperature of the cooling water, and a required interior space heating load, to heat the interior space.

If the main air conditioner device 520 is configured to be operated only in the interior space cooling cycle, and the sub-air conditioner device 530 is configured to be operated only in the interior space heating cycle, the controller 190 may heat the interior space by operating at least one of the sub-air conditioner device 530, or the first heat core 514 singly or simultaneously with reference to the outdoor temperature, the temperature of the cooling water, and the required interior space heating load. This case is identical to the embodiment of FIG. 1 described above.

In this case, the compressor 531 of the sub-air conditioner device 530 used only for interior space heating may have a capacity ⅓ of a capacity of the compressor 521 of the main air conditioner device 520, enabling reduced battery power consumption to drive the compressor 531.

If the main air conditioner device 520 is configured to be operated in the interior space cooling/heating cycle, and the sub-air conditioner device 530 is configured to be operated only in the interior space heating cycle, the controller 190 may heat the interior space by operating at least one of the main air conditioner device 520, the sub-air conditioner device 530, or the first heat core 514 singly or simultaneously with reference to the outdoor temperature, the temperature of the cooling water, and the required interior space heating load.

More particularly, the controller 190 may meet the required interior space heating load of the interior space by operating the main air conditioner device 520, the sub-air conditioner device 530, and the first heat core 514 simultaneously in a cold region in which the outdoor temperature is below a predetermined temperature (for example, approximately −7° C.). Moreover, by selective operation of the main air conditioner device 520 having a larger interior space heating capacity and the sub-air conditioner device 530 having a smaller interior space heating capacity, the battery power consumption may be reduced, enabling increased mileage of the electric vehicle.

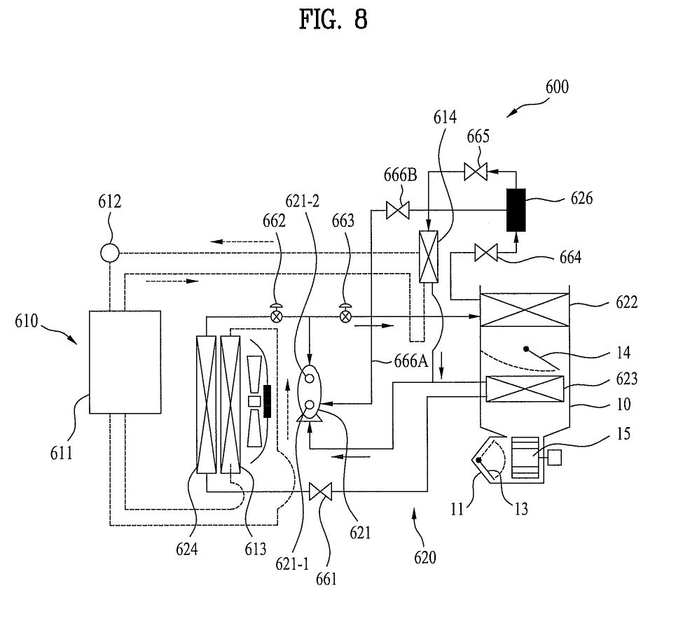

FIG. 8 is a schematic diagram of an air conditioner for a hybrid electric vehicle according to another embodiment. The air conditioner 600 according to this embodiment may include a waste heat recovery device 610 that recovers waste heat from the engine 611, and an air conditioner device 620.

Referring to FIG. 8, the waste heat recovery device 610 may include the engine 611, a radiator 613, and a heat core 614, through which the cooling water having the waste heat recovered from the engine 611 may flow. The waste heat recovery device 610 may further include a pump 612 that pumps cooling water.

In this embodiment, the heat core 614 may not heat the interior space directly using heat of the cooling water, but rather, may heat the refrigerant being introduced from an indoor heat exchanger 622 to a compressor 621 by heat exchanging with the refrigerant.

The air conditioner device 620 may include the compressor 621 that compresses the refrigerant, at least one indoor heat exchanger 622, an outdoor heat exchanger 624, and a plurality of valves 661 to 666B, that cool or heat the interior space. If a plurality of the indoor heat exchangers are provided, the indoor heat exchangers may be an indoor heating heat exchanger 622 and an indoor cooling heat exchanger 623. The indoor heating heat exchanger 622 and the indoor cooling heat exchanger 623 may be arranged in the duct 10.

The air conditioner device 620 may further include a gas/liquid separator 626 that separates refrigerant from the indoor heat exchanger 622 into gas refrigerant and liquid refrigerant. In this case, the gas refrigerant separated in the gas/liquid separator 626 may be supplied to the compressor 621 at an intermediate pressure.

The compressor 611 may have a plurality of stages or portions, for an example, a low pressure compression portion 621-1 and a high pressure compression portion 621-2. In more detail, the low pressure compression portion 621-1 may receive refrigerant from the indoor heat exchanger 622, and the high pressure compression portion 621-2 may receive the gas refrigerant separated at the gas/liquid separator 626. An injection pipeline 666A may be connected between the gas/liquid separator 626 and the high pressure compression portion 621-2, and an injection valve 666B may be provided on the injection pipeline 666A.

In summary, as the high pressure compression portion 621-2 may receive the gas refrigerant separated at the gas/liquid separator 626 and the refrigerant compressed at the low pressure compression portion 621-1 all together, compression work to be applied to the compressor 621 may be reduced, increasing an operation range of the compressor 621. That is, the air conditioner device 620 may be configured in an injection cycle.

Up to now, different embodiments with various structures of the air conditioner device and arrangements of the heat core(s) have been described. As described above, the technical characteristics described before are applicable not only to the embodiments disclosed herein, but to other embodiments as well.

In summary, the air conditioner for an electric vehicle according to embodiments may include an air conditioner device having a heat core that heats an interior space with cooling water having waste heat recovered from the engine, a compressor that compresses the refrigerant, at least one indoor heat exchanger, an outdoor heat exchanger, and a controller that controls operation of the engine, the heat core, and the air conditioner device. The controller may put at least one of the air conditioner device and the heat core into operation singly or simultaneously with reference to a temperature of the cooling water, an interior space temperature, an outdoor temperature, and an operation state of the electric vehicle, to heat the interior space.

As described above, at an initial running of the electric vehicle, the controller may put the air conditioner device and the heat core into operation simultaneously to heat the interior space, and if the required interior space heating load of the interior space can be met only with the air conditioner device, the engine may not be operated for operation of the heat core, additionally. More particularly, if the outdoor temperature is lower than a predetermined value, the cooling water may be introduced to a water jacket described to increase an initial heating rate, and reduce use of the engine. As described above, the heat core may be positioned closer to an air inlet than at least one indoor heat exchanger.

When the electric vehicle runs at a low speed, and the cooling water temperature is lower than the interior space temperature, the controller may put the air conditioner device into operation singly to heat the interior space. When the electric vehicle runs at a high speed, the controller may put the heat core into operation singly to heat the interior space. Of course, if there is shortage in heating capacity only with the heat core, the shortage of heating capacity may be supplemented by the air conditioner device.

The controller may operate the compressor at a maximum operation frequency at the initial running of the electric vehicle, and may lower the operation frequency if the temperature of the cooling water becomes high or the temperature of the interior space is within a preset range of temperature. That is, the compressor may be operated at a maximum rate in response to the required interior space heating load at the initial operation quickly, and if the temperature of the cooling water becomes high or the temperature of the interior space is within a preset range of temperature, battery power consumption may be reduced by gradually lowering an operation frequency of the compressor.

The compressor may be operated at ⅓ of a maximum operation frequency if the temperature of the cooling water is higher than a first temperature (for example, about 50° C.), and the compressor may not be operated if the temperature of the cooling water is higher than a second temperature (for example, about 60° C.), which is higher than the first temperature. As described above, as the required interior space heating load of the interior space may be met if the temperature of the cooling water is higher than about 60° C., battery power consumption for the compressor may be reduced.

The controller may operate the compressor at a maximum operation frequency continuously in a cold region in which the outdoor temperature is lower than a predetermined temperature (about −7° C.). As this case is a case when the outdoor temperature is very low, the compressor may be operated at the maximum operation frequency continuously to heat the interior space.

As discussed above, the controller may put the air conditioner device into operation in the battery running mode to heat the interior space first, and may put the heat core into operation first, in the engine operation mode, to heat the interior space.

Further, an air conditioner in or for an electric vehicle according to embodiments disclosed herein may minimize use of the battery and the engine to heat the interior space, thereby increasing mileage. Furthermore, an air conditioner in or for an electric vehicle according to embodiments disclosed herein may use the battery first to heat the interior space and reduce operation of the engine only to heat the interior space, permitting rapid heating, and improving viscosity of compressor oil.

Embodiments disclosed herein are directed to an air conditioner in or for a hybrid electric vehicle. Embodiments disclosed herein provide an air conditioner in or for a hybrid electric vehicle, which may minimize use of a battery and use of an engine for room or interior heating, thereby increasing mileage.

Embodiments disclosed herein further provide an air conditioner in or for a hybrid electric vehicle, which may use a battery at first for room or interior heating, and reduce operation of an engine only for room or interior heating. Embodiments disclosed herein additionally provide an air conditioner in or for a hybrid electric vehicle, which may enable rapid room or interior heating, and improve viscosity of compressor oil.

Embodiments disclosed herein provide an air conditioner in or for an electric vehicle having an engine, a motor, and a battery that drives the motor. The air conditioner may include a heat core for recovery of waste heat from the engine to heat a room or interior space, an air conditioner unit or device including a compressor driven by the motor, an indoor heat exchanger, and an outdoor heat exchanger, and a controller that controls operation of the engine, the heat core, and the air conditioner unit.

In running of the electric vehicle, the controller may put the air conditioner unit into operation to heat the room space at first in a battery running mode, and put the heat core into operation to heat the room space at first in an engine running mode. Different from this, when the electric vehicle stops, the controller may stop operation of the engine, and put the air conditioner unit into operation at first to heat the room space.

Embodiments disclosed herein provide an air conditioner in or for an electric vehicle that runs on a battery and an engine as driving sources. The air conditioner may include a heat core that heats a room or interior space with cooling water having waste heat recovered from the engine, an air conditioner unit or device including a compressor that compresses refrigerant, at least one indoor heat exchanger, an outdoor heat exchanger, and a controller that controls operation of the engine, the heat core, and the air conditioner unit.

The controller may operate at least one of the air conditioner unit or the heat core singly or simultaneously with reference to at least one of a temperature of the cooling water, a room temperature, an outdoor temperature, or a running state of the electric vehicle.

An air conditioner in or for an electric vehicle according to embodiments may minimize use of the battery and the engine to heat a room or interior space, thereby increasing mileage.

Further, an air conditioner in or for an electric vehicle according to embodiments disclosed herein may use a battery at first for room or interior space heating and reduce operation of the engine only for room or interior space heating, permit rapid room or interior heating, and improve viscosity of compressor oil.

It will be apparent to those skilled in the art that various modifications and variations can be made to embodiments without departing from the spirit or scope. Thus, it is intended that the embodiments invention covers modifications and variations provided they come within the scope of the appended claims and their equivalents.

Any reference in this specification to “one embodiment,” “an embodiment,” “example embodiment,” etc., means that a particular feature, structure, or characteristic described in connection with the embodiment is included in at least one embodiment of the invention. The appearances of such phrases in various places in the specification are not necessarily all referring to the same embodiment. Further, when a particular feature, structure, or characteristic is described in connection with any embodiment, it is submitted that it is within the purview of one skilled in the art to effect such feature, structure, or characteristic in connection with other ones of the embodiments.

Although embodiments have been described with reference to a number of illustrative embodiments thereof, it should be understood that numerous other modifications and embodiments can be devised by those skilled in the art that will fall within the spirit and scope of the principles of this disclosure. More particularly, various variations and modifications are possible in the component parts and/or arrangements of the subject combination arrangement within the scope of the disclosure, the drawings and the appended claims. In addition to variations and modifications in the component parts and/or arrangements, alternative uses will also be apparent to those skilled in the art.

What is claimed is:

1. An air conditioner for an electric vehicle including an engine, a motor, and a battery that drives the motor, the air conditioner comprising:
at least one heat core that recovers heat from the engine;
at least one air conditioner device including a compressor driven by the motor, at least one indoor heat exchanger, and an outdoor heat exchanger; and
a controller that controls operation of the engine, the at least one heat core, and the at least one air conditioner device, wherein the controller operates the at least one air conditioner device to heat the interior space first, in a battery running mode, and operates the at least one heat core to heat the interior space first, in an engine running mode.

2. The air conditioner as claimed in claim 1, wherein when the electric vehicle stops, the controller stops operation of the engine, and operates the at least one air conditioner device first to heat the interior space.

3. The air conditioner as claimed in claim 1, wherein the controller operates the at least one air conditioner device and the at least one heat core simultaneously to heat the interior space if an interior space heating capacity of the at least one air conditioner device is lower than a required interior space heating load, in a battery driving mode, and wherein the controller operates the at least one heat core and the at least one air conditioner device simultaneously to heat the interior space if an interior space heating capacity of the at least one heat core is lower than the required interior space heating load, in an engine driving mode.

4. The air conditioner as claimed in claim 1, wherein the controller heats the interior space using the at least one heat core in a state in which driving of the engine is stopped if the electric vehicle is changed from a running state to a stationary state and the interior space heating capacity of the at least one heat core is higher than the required interior space heating load, and wherein the controller heats the interior space by operating the at least one air conditioner device in a state in which the driving of the engine is stopped if the electric vehicle is changed from a running state to a stationary state and the interior space heating capacity of the at least one heat core is lower than the required interior space heating load.

5. The air conditioner as claimed in claim 1, wherein the at least one heat core is positioned closer to an air inlet than the at least one indoor heat exchanger.

6. The air conditioner as claimed in claim 1, wherein the at least one indoor heat exchanger comprises an indoor cooling heat exchanger and an indoor heating heat exchanger, and wherein the indoor cooling heat exchanger, the at least one heat core, and the indoor heating heat exchanger are arranged in succession starting from an air inlet to an air outlet.

7. The air conditioner as claimed in claim 6, wherein, if the interior space has a humidity lower than a predetermined value, the controller operates the indoor cooling heat exchanger and the indoor heating heat exchanger, simultaneously.

8. The air conditioner as claimed in claim 1, wherein, if a temperature of cooling water circulating through the at least one heat core is lower than a predetermined temperature, the controller operates the at least one heat core and the indoor heating heat exchanger simultaneously to heat the interior space, and if the temperature of the cooling water circulating through the at least one heat core is higher than the predetermined temperature, the controller operates only the at least one heat core to heat the interior space.

9. The air conditioner as claimed in claim 1, further comprising a water jacket provided on the compressor that passes the cooling water therethrough to recover waste heat from the engine.

10. The air conditioner as claimed in claim 9, wherein the controller controls the cooling water to be introduced to the at least one heat core directly if an outdoor temperature is higher than a predetermined value, and if the outdoor temperature is lower than the predetermined value, the controller controls the cooling water to be introduced to the at least one heat core after the cooling water has passed through the water jacket.

11. The air conditioner as claimed in claim 1, wherein the air conditioner device further comprises:
a separator that separates gas refrigerant from liquid refrigerant;
an injection line connected between the gas/liquid separator and the compressor; and
an injection valve provided on the injection line, wherein gas refrigerant separated at the separator is supplied to the compressor at an intermediate pressure through the injection line.

12. The air conditioner as claimed in claim 1, wherein the at least one air conditioner device comprises a main air conditioner device, and a sub-air conditioner device, wherein a compressor of the main air conditioner device has a capacity larger than a capacity of a compressor of the sub-air conditioner device, and wherein the indoor heat exchanger and the at least one heat core of the main air conditioner device and the indoor heat exchanger of the sub-air conditioner device are arranged in succession starting from an air inlet to an air outlet.

13. The air conditioner as claimed in claim 12, wherein the controller operates at least one of the main air conditioner device, the sub-air conditioner device, or the at least one heat core singly or simultaneously with reference to at least one of an outdoor temperature, a temperature of the cooling water, or a required interior space heating load.

14. The air conditioner as claimed in claim 13, wherein the controller operates the main air conditioner device, the sub-air conditioner device, and the at least one heat core simultaneously in a cold region having an outdoor temperature lower than a predetermined temperature.

15. An air conditioner for an electric vehicle including an engine, a motor, and a battery that drives the motor, the air conditioner comprising:
at least one heat core that recovers heat from the engine;
at least one air conditioner device including a compressor driven by the motor, at least one indoor heat exchanger, and an outdoor heat exchanger; and
a controller that controls operation of the engine, the at least one heat core, and the at least one air conditioner device, wherein the controller operates the at least one heat core and the at least one air conditioner simultaneously, if a temperature of cooling water circulating through the at least one heat core is equal to or lower than a predetermined temperature, and operates the at least one air conditioning device only if the temperature of the cooling water is higher than the predetermined temperature.

16. The air conditioner as claimed in claim 15, wherein when the at least one heat core and the at least one air conditioner are operated simultaneously, if an interior space heating capacity of the at least one heat core and the at least one air conditioner is lower than a required interior space heating capacity, the engine is operated.

17. The air conditioner as claimed in claim 15, wherein the at least one heat core comprises a plurality of heat cores that recover waste heat from the engine and wherein one of the plurality of heat cores heats the air of the interior space directly and another of the plurality of heat cores indirectly heats the air of the interior space.

18. The air conditioner as claimed in claim 17, wherein the one of the plurality of heat cores is positioned in the duct, and the another of the plurality of heat cores communicates with the at least one indoor heat exchanger to raise an evaporation temperature of the refrigerant of the at least one indoor heat exchanger.

19. The air conditioner as claimed in claim 17, wherein the cooling water passes through the plurality of heat cores in succession.

20. The air conditioner as claimed in claim 17, wherein the cooling water passes through a water jacket provided on the compressor to heat oil in the compressor.

21. An air conditioner for an electric vehicle that runs on a battery and an engine as driving sources, the air conditioner comprising:
at least one heat core that heats an interior space of the electric vehicle using cooling water having waste heat recovered from the engine;
at least one air conditioner device including a compressor that compresses refrigerant, at least one indoor heat exchanger, and an outdoor heat exchanger; and
a controller that controls operation of the engine, the at least one heat core, and the at least one air conditioner device, wherein the controller operates at least one of the at least one air conditioner device or the at least one heat core singly or simultaneously with reference to at least one of a temperature of the cooling water, an interior space temperature, an outdoor temperature, or a running state of the electric vehicle, and wherein the controller reduces by steps a compression frequency of the at least one air conditioner with reference to at least one of the temperature of the cooling water, the outdoor temperature, or a heating load if the outdoor temperature increases, the temperature of the cooling water increases, or the heating load decreases, respectively.

22. The air conditioner as claimed in claim 21, wherein the controller operates the at least one air conditioner device and the at least one heat core at the same time to heat the interior space at an initial running of the electric vehicle.

23. The air conditioner as claimed in claim 21, wherein the controller heats the interior space by operating only the at least one air conditioner device if the temperature of the cooling water is lower than the temperature of the interior space in a slow speed running of the electric vehicle.

24. The air conditioner as claimed in claim 21, wherein the controller heats the interior space by operating only the at least one heat core singly in a high speed running of the electric vehicle.

25. The air conditioner as claimed in claim 21, wherein the controller operates the compressor at a maximum operation frequency at an initial running, and if the temperature of the cooling water increases or the temperature of the interior space is within a preset range of temperature, lowers an operation frequency of the compressor.

26. The air conditioner as claimed in claim 21, wherein the controller operates the compressor at ⅓ of a maximum operation frequency if the temperature of the cooling water is higher than a first temperature, and turns off the compressor if the temperature of the cooling water is higher than a second temperature, which is higher than the first temperature.

27. The air conditioner as claimed in claim 21, wherein the controller operates the compressor at the maximum operation frequency continuously in a cold region having an outdoor temperature lower than a predetermined temperature.

28. The air conditioner as claimed in claim 21, wherein the compressor is provided with a water jacket that passes therethrough the cooling water having waste heat recovered from the engine, and wherein the controller controls the cooling water to be introduced to the at least one heat core after the cooling water passes through the water jacket if the outdoor temperature is lower than the predetermined temperature.

29. The air conditioner as claimed in claim 21, wherein the controller operates the at least one air conditioner device to heat the interior space first, in a battery running mode, and operates the at least one heat core to heat the interior space first, in an engine running mode.

30. The air conditioner as claimed in claim 21, wherein the at least one air conditioner device comprises a main air conditioner device, and a sub-air conditioner device, wherein a compressor of the main air conditioner device has a capacity larger than a capacity of a compressor of the sub-air conditioner device, and wherein the indoor heat exchanger and the at least one heat core of the main air conditioner device and the indoor heat exchanger of the sub-air conditioner device are arranged in succession starting from an air inlet to an air outlet.

31. An air conditioner for an electric vehicle including an engine, a motor, and a battery that drives the motor, the air conditioner comprising:
at least one heat core that recovers heat from the engine;
at least one air conditioner device including a compressor driven by the motor, at least one indoor heat exchanger, and an outdoor heat exchanger; and
a controller that controls operation of the engine, the at least one heat core, and the at least one air conditioner device, wherein if a temperature of cooling water circulating through the at least one heat core is greater than or equal to an outdoor temperature, the controller controls refrigerant of the at least one air conditioner to heat exchange with the at least one heat core and if the temperature of the cooling water is less than the outdoor temperature, the controller controls the refrigerant to heat exchange with the outdoor heat exchanger.
